(19) United States
(12) Patent Application Publication
(10) Pub. No.: US 2011/0082734 A1
(43) Pub. Date: Apr. 7, 2011

(54) LOCATING BUNDLED ITEMS

(76) Inventors: Haining Zhang, ShangHai (CN); Oian Sun, ShangHai (CN); Yang Zhou, ShangHai (CN); Jian Xu, ShangHai (CN); Yi Zhou, ShangHai (CN); Marni Susan Deshong, Richmond, CA (US); Xiaobo Wu, ShangHai (CN)

(21) Appl. No.: 12/573,000

(22) Filed: Oct. 2, 2009

(51) Int. Cl. G06F 7/10; G06F 17/30; G06Q 10/00; G06Q 30/00

(52) U.S. Cl. 705/14.23; 705/28; 707/E17.108; 705/26.25

(57) ABSTRACT

In an example embodiment, a method is provided of locating a bundle of items. In this method, a query for a first item is received, and a search for the first item is conducted based on the query to locate an attribute of the first item. An identification is then made from the attribute that the first item is associated with the bundle of items. Another search for a second item that is associated with the bundle is conducted based on the attribute. A listing is then generated of the first item with the second item grouped as a bundle.

### FIELD

The present disclosure relates generally to information retrieval. In an embodiment, the disclosure relates to locating bundled items.

### BACKGROUND

Online shopping and auction websites provide a number of publishing, listing, and price-setting mechanisms whereby a seller may list (or publish information concerning) items for sale. A buyer can express interest in or indicate a desire to purchase such items by, for example, submitting a query to the website for use in a search of the requested items.

The matching of a query to relevant items can be inaccurate in information retrieval. As an example, item descriptions (e.g., title) tend to be short and such descriptions may be uniquely defined by the sellers. The buyers seeking to purchase the items might use a different vocabulary from the vocabulary used by the sellers to describe the items. The mismatch of vocabulary may result in the retrieval of non-relevant items.

### BRIEF DESCRIPTION OF DRAWINGS

The present disclosure is illustrated by way of example and not limitation in the figures of the accompanying drawings, in which like references indicate similar elements and in which:

FIGS. 1A and 1B are user interface diagrams, consistent with embodiments of the present invention, showing an input of a query to locate bundled items;

FIG. 2 is a block diagram depicting examples of modules, in accordance with one embodiment, included in a processing system that is configured to locate bundled items;

FIG. 3 is a flow diagram depicting a general overview of a method, in accordance with an embodiment, for locating bundled items;

FIGS. 4A and 4B show examples of data structures, in accordance with some embodiments, that are configured to store attributes and other information associated with items;

FIG. 5 is a block diagram showing a system, in accordance with some embodiments, for locating bundled items;

FIG. 6 is a flow diagram showing a detailed method, in accordance with an alternate embodiment, for locating bundled items and sorting a listing of the bundled items;

FIG. 7 is a flow diagram depicting a method, in accordance with one embodiment, for unbundling bundled items based on inventory; and

FIG. 8 depicts a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

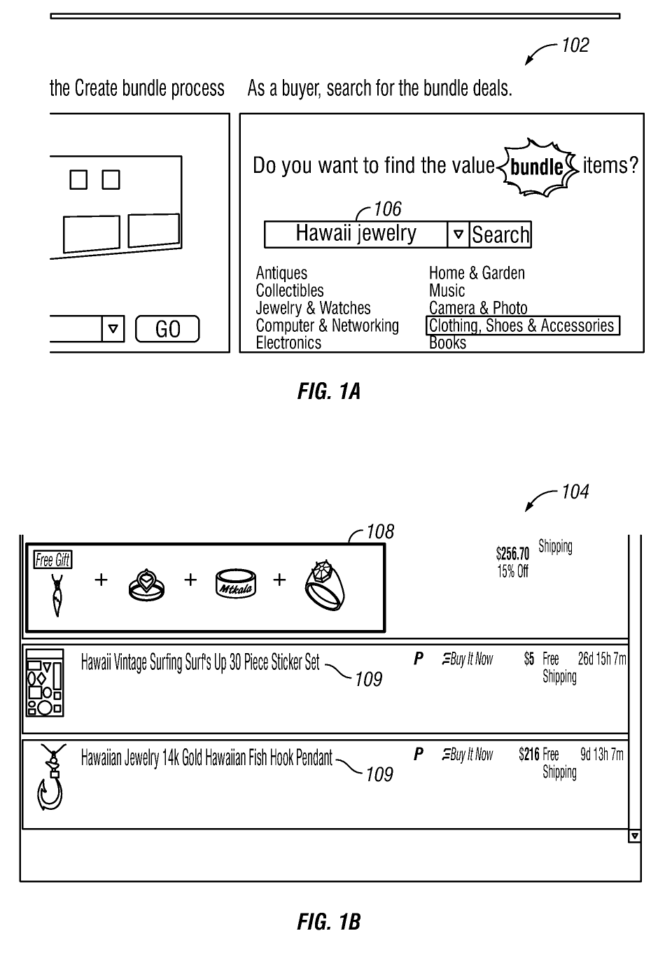

FIGS. 1A and 1B are user interface diagrams, consistent with embodiments of the present invention, showing an input of a query to locate bundled items. A user may input or submit a query to an online shopping, auction, or other electronic commerce website to locate one or more items. As used herein, a “query” is an enquiry directed at one or more information resources. As an example, a query may be an enquiry about one or more items, which include any tangible or intangible thing and/or something that has a distinct, separate existence from other things (e.g., goods, services, electronic files, and land). The terms included in the query may include keywords, numbers, symbols, and other alphanumeric characters. FIG. 1A depicts a user interface 102 that includes a user interface region 106 that accepts query inputs. In this example, a user wants to locate certain types of jewelry from Hawaii. As a result, the user inputs a query with keywords “Hawaii jewelry” to locate items with, for example, titles or descriptions that include these keywords.

The query is then transmitted to an electronic commerce system, which searches through its database to locate or identify all the items that satisfy the query. In addition to locating individual items, embodiments of the present invention can also locate bundled items. As used herein, a “bundle” refers to multiple items or a quantity of items grouped or bound together. As depicted in FIG. 1B, the electronic commerce system provides another user interface region 104 that includes a listing of individual items and bundled items that satisfy the query. In particular, a sub-region 108 of the user interface region 104 displays a number of items grouped as a bundle. The additional sub-regions 109 of the user interface region 104 display a listing of individual items that satisfy the same query. From the user interface region 104, the user may select one or more individual items or bundled items for purchase.

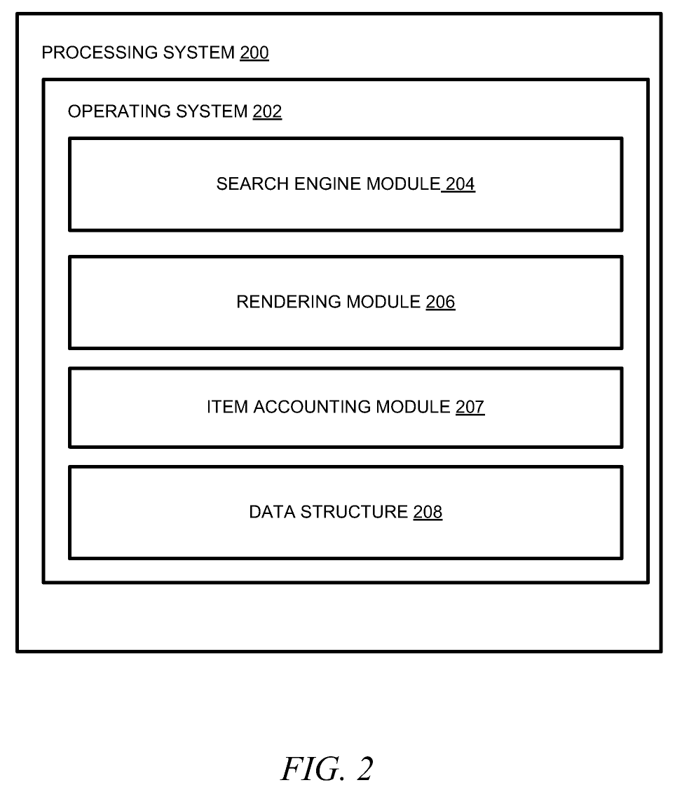

FIG. 2 is a block diagram depicting examples of modules, in accordance with one embodiment, included in a processing system 200 that is configured to locate bundled items. It should be appreciated that the processing system 200 may be deployed in the form of a variety of computing devices, such as server computers, personal computers, personal digital assistants, and other computing devices. The processing system 200 may be included in an electronic commerce system, an example of which is described in more detail below. In various embodiments, the processing system 200 may be used to implement computer programs, logic, applications, methods, or processes to locate bundled items, as is also described in more detail below.

The processing system 200 executes an operating system 202 that manages the software processes and/or services executing on the processing system 200. As depicted in FIG. 2, these software processes and/or services may include a search engine module 204, a rendering module 206, an item accounting module 207, and a data structure 208. The data structure 208 provides context for the organization of data. Examples of the data structure 208 include tables, arrays, linked lists, and databases. The data structure 208 stores attribute information associated with various items. An “attribute,” as used herein, refers to a quality belonging to an item, which may, for example, be defined in a title assigned to an item or defined in a description associated with the item. Examples of attributes include size, shape, color, construction material, country of manufacture, brand name, category assigned to the item, serial number, price, discount, and other attributes. Such attributes may be provided by, for example, sellers of the items. It should also be noted that each attribute may be assigned values. For example, example, an attribute (e.g., bundle identifier) may be respectively associated with different values (e.g., 0, 1, 2, 3, . . . n) to form multiple attribute-value pairs where each attribute-value pair is associated with a different item.

The search engine module 204 is configured to search for items based on one or more queries. In this example, the search engine module 204 searches the attributes stored in the data structure 208. For example, the search engine module 204 may search titles of the items to identify keywords that match keywords of the query. Embodiments of the search engine module 204 may also locate bundled items in the search. As explained in more detail below, bundled items may be identified with a particular attribute stored in the data structure 208.

After the bundled items are located, the search engine module 204 generates a listing of the bundled items, as well as individual items located from the search, and provides this listing to the rendering module 206. The rendering module 206 is configured to display the listing of the bundled items and the individual items. For example, the rendering module 206 may display a listing in the user interface depicted in FIGS. 1A and 1B. Upon selection by a user of one or more bundled items from the listing, the item accounting module 207 may, for example, thereafter apply discounts to prices of the bundled items, as described in more detail below.

It should be appreciated that in other embodiments, the processing system 200 may include fewer, more, or different modules apart from those shown in FIG. 2. For example, in another embodiment, the operating system 202 may not include a rendering module 206. Alternatively, the data structure 208 may be located at a different processing system 200.

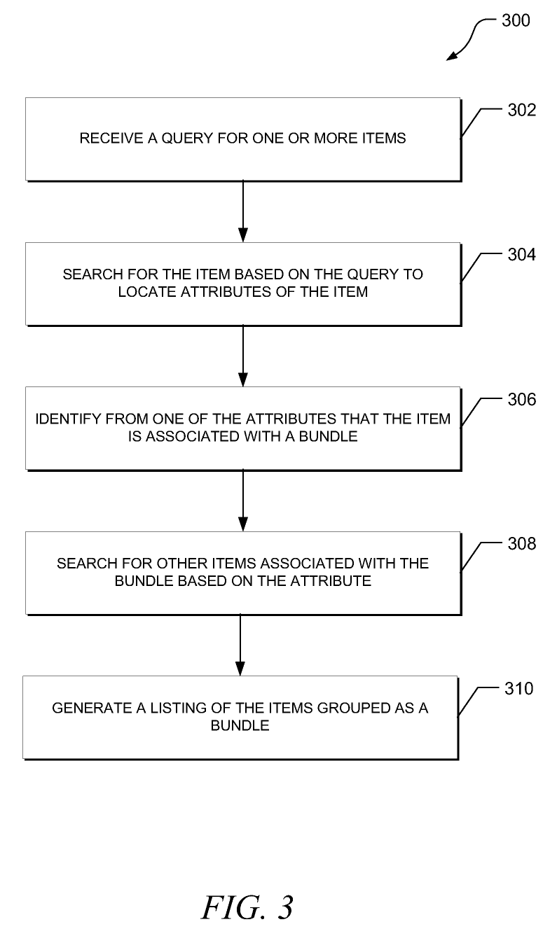

FIG. 3 is a flow diagram depicting a general overview of a method 300, in accordance with an embodiment, for locating bundled items. In one embodiment, the method 300 may be implemented by the search engine module 204, and employed in the processing system 200 depicted in FIG. 2. As depicted in FIG. 3, a query for one or more items is received at 302. Upon receipt of the query, a search is conducted at 304 for the items based on the query to locate the items' attributes.

In one embodiment, a particular attribute may be assigned to an item that identifies the item to be associated with or included in a bundle. This attribute may include a variety of different values or indicators that identify the bundling of items. As an example, in one embodiment, this attribute may be a bundle identifier. A “bundle identifier,” as used herein, refers to an attribute with a value (numeric and/or textual) that uniquely identifies a particular bundle. As explained in more detail below, the bundle identifier may be stored with other attributes associated with an item or may be stored in a separate data structure that is specifically used for a lookup of bundled items. In another embodiment, this attribute may be a pointer that points to other items associated with the bundle, thereby identifying all the items that are associated with the same bundle.

As depicted at 306, identification is made from this particular attribute (e.g., bundle identifier) that the item located is associated with a bundle. As a result, a search may then be conducted at 308 for other items associated with the bundle based on this attribute, as will be explained in more detail below. After the other bundled items are located or identified, a listing of the items grouped as a bundle is then generated at 310.

It should be appreciated that locating bundled items may expand a search because, for example, results of such a search may include related bundled items that would otherwise not be located. In addition, the listing of bundled items may also provide the user with a convenient way to search for multiple items in a single search rather than searching for each item individually. The listings of bundled items and individual items may also, for example, provide a user with more purchasing or bidding options (e.g., purchase individual item or bundled items).

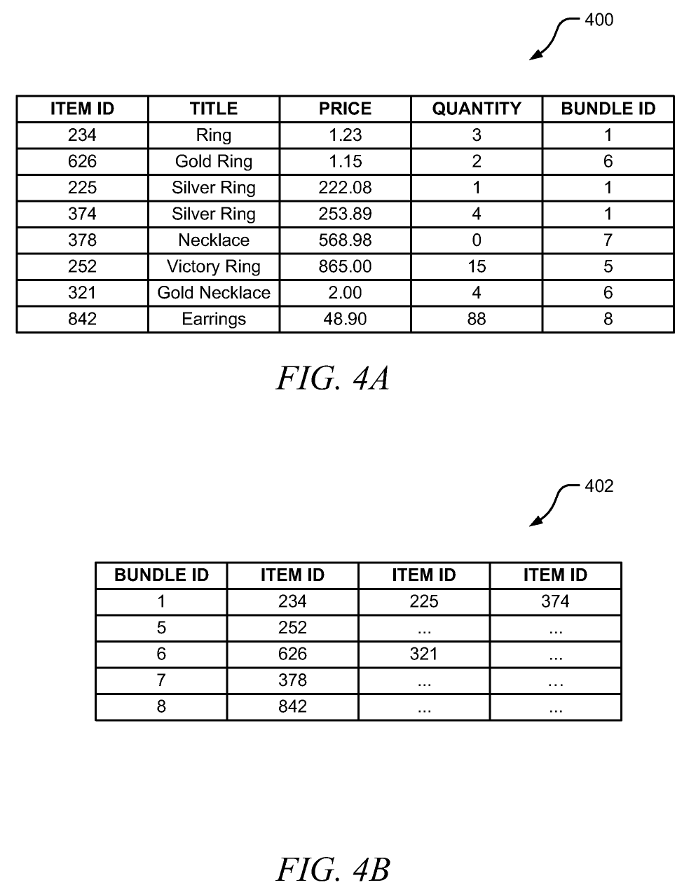

FIGS. 4A and 4B show examples of data structures, in accordance with some embodiments, that are configured to store attributes and other information associated with items. As discussed above, the attributes can be stored in a variety of different data structures, and FIG. 4A shows an example of such a data structure in the form of a database table 400. A database table 400 is a set of data elements organized in columns and rows. In this example, each column is configured to store a particular attribute associated with multiple items. As depicted, the attributes include item identifiers, titles, prices, quantities, and bundle identifiers. An item identifier refers to a value (numeric and/or textual) that uniquely identifies one item. A primary key, for example, may be used as item identifiers. In this example, a record or row of values includes all the attributes associated with a particular item. For example, the item with item identifier “234” has a title “Ring,” a price of $1.23, a quantity of 3, and a bundle identifier of “1.” In another example, the item with item identifier “626” has a title “Gold Ring,” a price of $1.15, a quantity of 2, and a bundle identifier of “6.”

In an illustrative example, a search may result in the location of an item with item identifier “234” where its title matches the keywords of a query. A search engine module, for example, identifies that a bundle identifier of “1” is assigned to this particular item. To identify all other items bundled with this particular item, the search engine module may then search for all other items having the bundle identifier of “1.” As depicted in FIG. 4A, items with item identifiers “225” and “374” also have the same bundle identifier of “1.” As a result, all three of these items belong to a single bundle, and they are grouped in the listing as a bundle.

In an alternate embodiment, the bundle identifier may be stored in a separate data structure that is particularly configured to store a mapping of items to their bundle identifiers. FIG. 4B depicts an example of such a database table 402. This database table 402 also is a set of data elements organized in columns and rows. In this example, the columns are configured to store bundle identifiers and item identifiers and a single row stores a record of all the item identifiers that belong to a particular bundle identifier. For example, from the database table 402, the item identifiers “626” and “321” are associated with bundle identifier “6.”

In an illustrative example, after a particular bundle identifier is identified, the search engine may refer to database table 402 to identify all item identifiers that are associated with a particular bundle identifier. For example, instead of searching through all the records of the database table 400 depicted in FIG. 4A for items that are associated with the bundle identifier of “1,” the search engine module may search database table 402, which is depicted in FIG. 4B, to quickly locate or identify all its associated item identifiers “234,” “225,” and “374.”

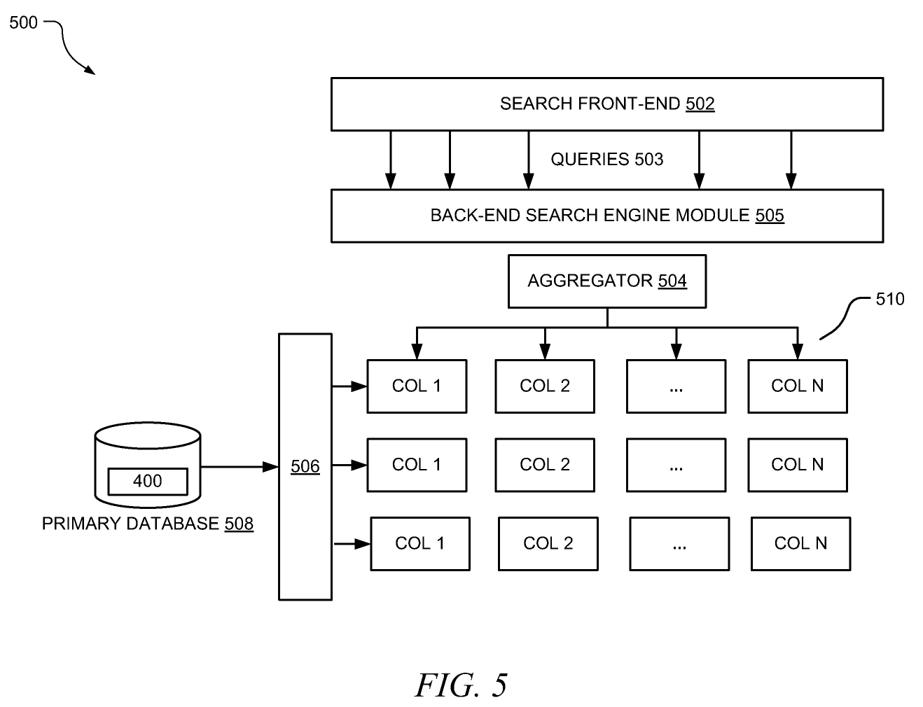

FIG. 5 is a block diagram showing a system 500, in accordance with some embodiments, for locating bundled items. The system 500 may, for example, be a part of an electronic commerce system, which includes a search front-end 502, a back-end search engine module 505, an aggregator 504, a search index 510, a feeder module 506, and a primary database 508. In this system 500, the database table 400 depicted in FIG. 4A, for example, may be stored in the primary database 508. Given that a search of the primary database 508 may take time, the system 500 may construct a search index 510 for use in, for example, increasing a speed of a search.

The search index 510 may, for example, be a snapshot of a portion of data stored in the primary database 508. The search index 510 is divided into a grid of N columns by, for example, modulo of a key. Each record or slice may be replicated to M instances (or rows). The feeder module 506 extracts a portion of data from the primary database 508 to include in the search index 510. As a result, the back-end search engine module 505 may search the search index 510 rather than search the primary database 508.

The search front-end 502 may be located at a client computing device and is configured to convert user inputs into queries 503 and to transmit the queries 503 to the back-end search engine module 505 for a search to locate, for example, bundled items. The back-end search engine module 505 is an example of a search engine that may be located at a server, which is in communication with the client computing device.

The aggregator 504 accesses queries 503 from the back-end search engine module 505 and, for example, parallelizes the queries 503 to one node in each column. Items that are associated with bundles may be quickly identified or located using the search index 510. The aggregator 504 also aggregates the results of a search (e.g., a listing) and transmits the results by way of the back-end search engine module 505 to the search front-end 502, which may organize the query response into information used in, for example, a Web page with depictions of the search results.

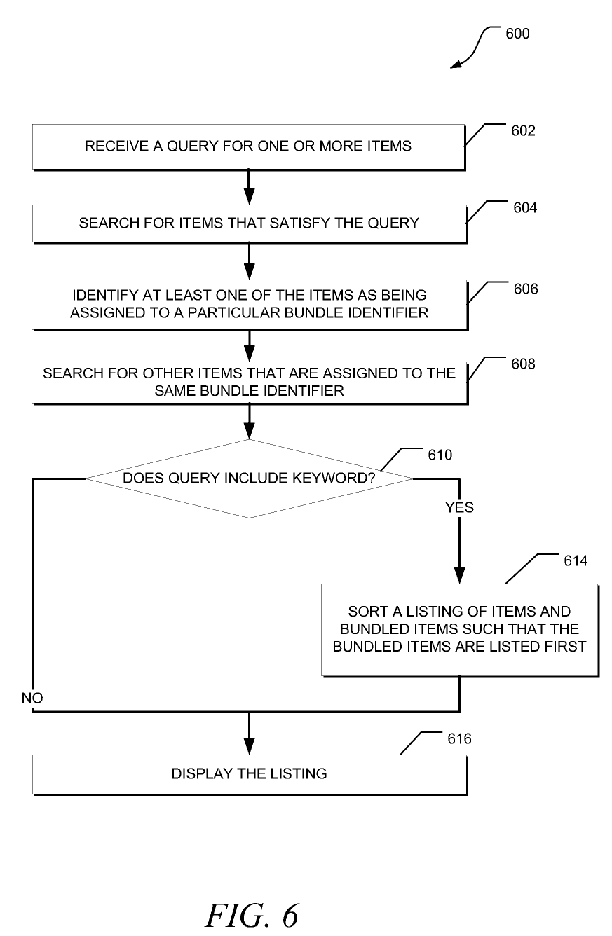

FIG. 6 is a flow diagram showing a detailed method 600, in accordance with an alternate embodiment, for locating bundled items and sorting a listing of the bundled items. In an embodiment, the method 600 may be implemented by the search engine module 204 and the rendering module 206, and employed in the processing system 200 depicted in FIG. 2. In FIG. 6, a search engine module receives a query for one or more items at 602, and the search engine module then searches for items that satisfy the query at 604.

From a search, the search engine module at 606 identifies at least one of the items having a bundle identifier. As a result of the identification, the search engine module conducts another search at 608 for other items having the same bundle identifier. Thereafter, the search engine module analyzes the keywords of the query to identify whether any of these keywords refers to a request for a listing with bundled items. It should be noted that a user may specify to a search engine module that he wants or prefers a search for bundled items, rather than individual items, by including particular keywords in the query. This keyword from the query effectively identifies the items being located with a bundle. That is, this keyword effectively communicates a user preference for a search for bundled items rather than a search that is solely for individual items. Examples of such keywords include “bundle,” “group,” and “package.” As a result, for example, a user may input a query with keywords “shoes bundle” to indicate a preference for the search to locate bundled shoes rather than, for example, individual shoes.

The search engine then sorts the listing of items located from the search based on the identification of such “bundle” keywords. For example, as depicted at 610 and 614, if the query includes such a keyword, then the listing of items is sorted such that the bundled items are listed first. In other words, the listing of items may be sorted such that the bundled items are listed before the individual items. As a result, the listing may, for example, provide a more relevant listing to a user that prefers a search for bundled items.

On the other hand, if the query does not include such keywords, then the listing of items is not sorted based on bundled items. However, it should be noted that in this example, the listing of items may be still be sorted based on other criteria (e.g., sorted by alphabetical order or by date). This listing may, for example, provide a more relevant listing to a user that did not specify his preference for bundled items. After the listing of items is sorted, the rendering module then displays the sorted listing at 616.

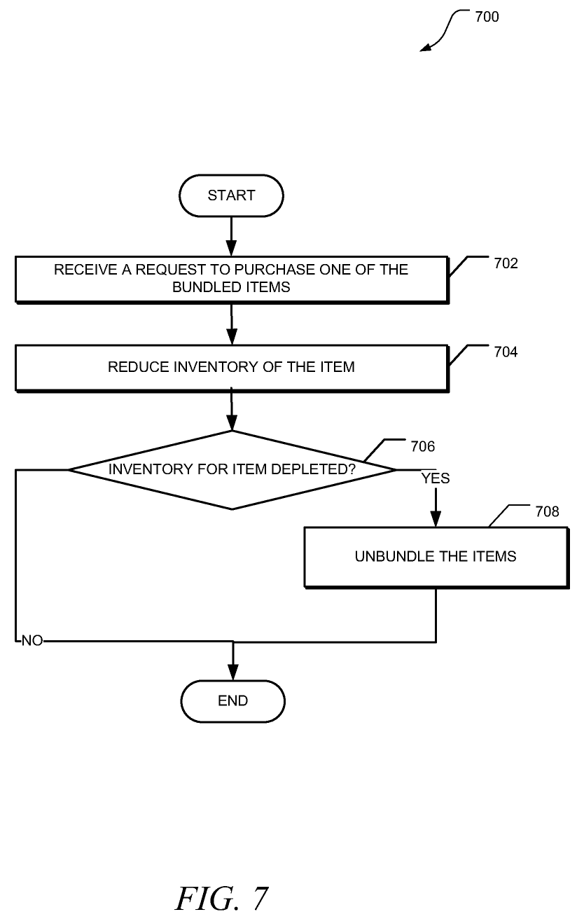

FIG. 7 is a flow diagram depicting a method 700, in accordance with one embodiment, for unbundling bundled items based on inventory. In an embodiment, the method 700 may be implemented by the item accounting module 207 and employed in the processing system 200 of FIG. 2. As depicted in FIG. 7, the item accounting module 207, for example, receives a request to purchase one of the bundled items at 702. In other words, a request is made to purchase only one of the items within the bundle rather than all the items of the bundle. A user, for example, may submit the request from a listing of individual items as well as bundled items.

Upon receipt of the request, the item accounting module reduces the inventory for that requested item at 704. The inventory may be reduced by, for example, subtracting a number of the items requested by the user from a total number of the item in the inventory. As depicted in 706, identification is then made after the reduction as to whether the inventory for that particular item is depleted. An inventory can be considered to be depleted when the item is sold out or when reduced to a certain low, pre-defined threshold number.

If the inventory for the requested item is not depleted, then the method 700 ends. On the other hand, if the inventory for the requested item is depleted, then the item accounting module unbundles all the bundled items at 708. These bundled items are unbundled because there are insufficient items (e.g., inventory depletion) to make up or constitute a bundle. In one embodiment, the unbundling of the items may comprise deleting the particular attribute (e.g., bundle identifier) that identifies these items being associated with a bundle. In an alternate embodiment, the unbundling of the items may comprise modifying the particular attribute to a different value that identifies the items to be disassociated with a bundle. For example, a bundle identifier of “0” may be used to define an item as not bundled. Therefore, to unbundle an item having, for example, a bundle identifier of “1,” this bundle identifier may be modified to a value of “0” when unbundled.

It should be appreciated that in other embodiments, additional discounts may be applied to a purchase of bundle items. As an example, upon receipt of a request to purchase bundled items, the item accounting module may identify a particular discount associated with the bundle. Such a discount, for example, may be a particular percentage off the total price of the bundled items. In another example, the discount may be a particular percentage off the shipping price of the bundled items. Such a discount may be stored as an attribute associated with one or more items and applied to the price of the bundled items when sold.

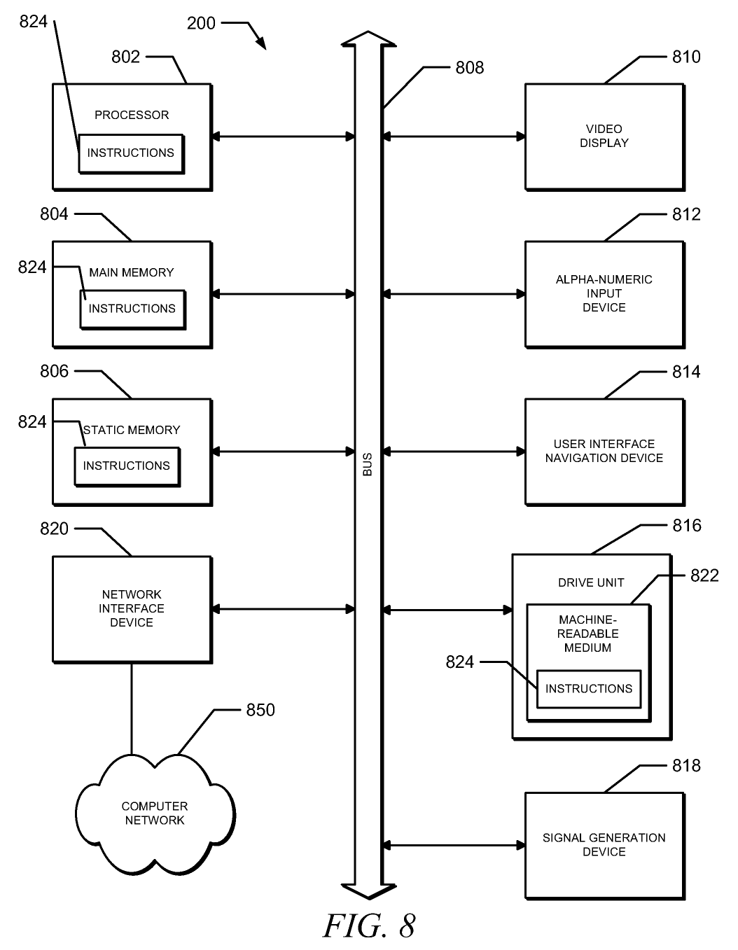

FIG. 8 depicts a block diagram of a machine in the example form of a processing system 200 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Embodiments may also, for example, be deployed by Software-as-a-Service (SaaS), Application Service Provider (ASP), or utility computing providers, in addition to being sold or licensed via traditional channels.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 200 includes a processor 802 (e.g., a central processing unit (CPU), a graphics processing unit (GPU) or both), a main memory 804 (e.g., random access memory (a type of volatile memory)), and static memory 806 (e.g., static random access memory (a type of volatile memory)), which communicate with each other via bus 808. The processing system 200 may further include video display unit 810 (e.g., a plasma display, a liquid crystal display (LCD) or a cathode ray tube (CRT)). The processing system 200 also includes an alphanumeric input device 812 (e.g., a keyboard), a user interface (UI) navigation device 814 (e.g., a mouse), a disk drive unit 816, a signal generation device 818 (e.g., a speaker), and a network interface device 820.

The disk drive unit 816 (a type of non-volatile memory storage) includes a machine-readable medium 822 on which is stored one or more sets of data structures and instructions 824 (e.g., software) embodying or utilized by any one or more of the methodologies or functions described herein. The data structures and instructions 824 may also reside, completely or at least partially, within the main memory 804 and/or within the processor 802 during execution thereof by processing system 200, with the main memory 804 and processor 802 also constituting machine-readable, tangible media.

The data structures and instructions 824 may further be transmitted or received over a computer network 850 via network interface device 820 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 200) or one or more hardware modules of a computer system (e.g., a processor 802 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 802 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 802 configured using software, the general-purpose processor 802 may be configured as respective different hardware modules at different times. Software may accordingly configure a processor 802, for example, to constitute a particular hardware module at one instance of time and to constitute a different hardware module at a different instance of time.

Modules can provide information to, and receive information from, other hardware modules. For example, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 802 or processor-implemented modules. The performance of certain of the operations may be distributed among the one or more processors 802, not only residing within a single machine, but deployed across a number of machines. In some example embodiments, the processor or processors 802 may be located in a single location (e.g., within a home environment, an office environment or as a server farm), while in other embodiments the processors 802 may be distributed across a number of locations.

While the embodiment(s) is (are) described with reference to various implementations and exploitations, it will be understood that these embodiments are illustrative and that the scope of the embodiment(s) is not limited to them. In general, techniques for locating bundled items may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A computer-implemented method of locating a bundle of a plurality of items, the method comprising:
receiving a query for a first item;
searching for the first item based on the query to locate an attribute of the first item;
identifying from the attribute that the first item is associated with the bundle of the plurality of items;
searching for a second item that is associated with the bundle based on the attribute; and
generating a listing of the first item with the second item grouped as the bundle.

2. The computer-implemented method of claim 1, wherein the attribute is a particular bundle identifier that identifies the bundle, and wherein the search for the second item comprises searching for the plurality of items having the particular bundle identifier, the second item being one of the plurality of items.

3. The computer-implemented method of claim 1, further comprising:
identifying a keyword from the query that associates the first item with the bundle;
compiling a further listing that includes the listing and another listing of the first item as a separate item; and
sorting the further listing based on the identification of the keyword,
wherein the generating the listing comprises generating the further listing as sorted.

4. The computer-implemented method of claim 1, wherein the first item is associated with a first price and the second item is associated with a second price, the method further comprising:
receiving a request to purchase the bundle of the plurality of items;
identifying a discount associated with the bundle; and
applying the discount to the first price and the second price.

5. The computer-implemented method of claim 1, further comprising:
receiving a request to purchase an item from the bundle of the plurality of items;
reducing an inventory of the item based on the request;
identify a depletion of the inventory after the reduction; and
unbundling the plurality of items.

6. The computer-implemented method of claim 5, wherein the unbundling of the plurality of items comprises deleting the attribute.

7. The computer-implemented method of claim 5, wherein the unbundling of the plurality of items comprises modifying the attribute to identify an unbundling of the plurality of items.

8. A machine-readable medium that stores instructions, which, when performed by a machine, cause the machine to perform operations comprising:
receiving a query for a first item;
searching for the first item based on the query to locate an attribute of the first item;
identifying from the attribute that the first item is associated with a bundle of a plurality of items;
searching for a second item that is associated with the bundle based on the attribute; and
generating a listing of the first item with the second item grouped as the bundle.

9. The machine-readable medium of claim 8, wherein the attribute is a particular bundle identifier that identifies the bundle, and wherein the operation of searching for the second item comprises searching for the plurality of items having the particular bundle identifier, the second item being one of the plurality of items.

10. The machine-readable medium of claim 8, further comprising:
identifying a keyword from the query that associates the first item with the bundle;
compiling a further listing that includes the listing and another listing of the first item as a separate item; and
sorting the further listing based on the identification of the keyword,
wherein the generating the listing comprises generating the further listing as sorted.

11. The machine-readable medium of claim 8, wherein the first item is associated with a first price and the second item is associated with a second price, the operations further comprising:
receiving a request to purchase the bundle of the plurality of items;
identifying a discount associated with the bundle; and
applying the discount to the first price and the second price.

12. The machine-readable medium of claim 8, further comprising:
receiving a request to purchase an item from the bundle of the plurality of items;
reducing an inventory of the item based on the request;
identify a depletion of the inventory after the reduction; and
unbundling the plurality of items.

13. The machine-readable medium of claim 12, wherein the operation of unbundling the plurality of items comprises deleting the attribute.

14. The machine-readable medium of claim 12, wherein the operation of unbundling the plurality of items comprises modifying the attribute to identify an unbundling of the plurality of items.

15. A processing system comprising:
at least one processor; and
a memory in communication with the at least one processor, the memory being configured to store a search engine module that is executable by the at least one processor, the search engine module having instructions that, when executed by the at least one processor, cause operations to be performed, the operations comprising:
receiving a query for a first item;
searching for the first item based on the query to locate an attribute of the first item;
identifying from the attribute that the first item is associated with a bundle of a plurality of items;
searching for a second item that is associated with the bundle based on the attribute; and
providing a listing of the first item with the second item grouped as the bundle.

16. The processing system of claim 15, wherein the attribute is a bundle identifier that identifies the bundle, and wherein the operation of searching for the second item comprises searching for the plurality of items having the particular bundle identifier, the second item being one of the plurality of items.

17. The processing system of claim 15, wherein the operations further comprise:
identifying a keyword from the query that associates the first item with the bundle;
compiling a further listing that includes the listing and another listing of the first item as a separate item; and
sorting the further listing based on the identification of the keyword,
wherein the providing the listing comprises providing the further listing as sorted.

18. The processing system of claim 15, wherein the first item is associated with a first price and the second item is associated with a second price, the operations further comprising:
receiving a request to purchase the bundle of the plurality of items;
identifying a discount associated with the bundle; and
applying the discount to the first price and the second price.

19. The processing system of claim 15, wherein the memory is further configured to store an item accounting module that is executable by the at least one processor, the item accounting module having instructions that when executed by the at least one processor, cause operations to be performed, the operations comprising:
receiving a request to purchase an item from the bundle of the plurality of items;
reducing an inventory of the item based on the request;
identify a depletion of the inventory after the reduction; and
unbundling the plurality of items.

20. A processing system for locating a bundle of a plurality of items, the processing system comprising:
a search engine to:
receive a query for a first item;
search for the first item based on the query to locate an attribute of the first item;
identify from the attribute that the first item is included in the bundle of the plurality of items; and
search for a second item that is included in the bundle based on the attribute; and
a rendering engine to display a listing of the first item with the second item grouped as the bundle.
